(19) United States
(12) Patent Application Publication
(10) Pub. No.: US 2010/0100875 A1
(43) Pub. Date: Apr. 22, 2010

(54) METHOD AND DEVICE FOR PROCESSING CONFIGURATION REPORTS

(75) Inventor: Olivier BASTIEN, La Salvetat Saint Gilles (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Airbus Operations, Toulouse (FR)

(21) Appl. No.: 12/572,484

(22) Filed: Oct. 2, 2009

(30) Foreign Application Priority Data
Oct. 16, 2008 (FR) 08 05734

(51) Int. Cl. G06F 9/44

(52) U.S. Cl. 717/168

(57) ABSTRACT

The method for processing of at least one software configuration report for a data-processing equipment item comprises, for each equipment item:
a step (435) of determining, by a system remote from the said equipment item, of a verification sum calculated on a nominal product reference list for the pieces of software accommodated by the said equipment item,
a step (480) of determining, by the said equipment item, of a verification sum calculated on a product reference list for the pieces of software actually accommodated by the said equipment item,
a step (490) of transmitting the said verification sum determined by the said equipment item, and
a step (495) of comparing the verification sums.

Preferentially, each verification sum depends on an information item representative of the location of the equipment item considered.

This invention relates to a method and a device for processing of configuration reports. It applies, in particular, to the reporting, verification and updating of avionic equipment item configurations.

The new generation of aircraft makes intensive use of uploading (“uploading”) on the on-board avionic computer (called “Field Loadable Software”).

This technology allows:

easier system corrections through software modification without affecting the hardware portions of the equipment item,

easier system changes through software updating without affecting the hardware portion of the equipment item,

reuse of equipment items among different airplane programs with only one software change.

Such a generalization of the “Field Loadable Software” leads to a need for a function allowing each equipment item capable of receiving an uploaded piece of software to provide a report on its configuration for the maintenance operator for configuration management requirements on the ground.

On standard airplane designs, the configuration is managed by the engineering of the user airline companies, employing a system of reference on the ground in which the configurations of each equipment item on board each airplane are recorded, in particular the location of the equipment item, its personal identification number, its serial number and each piece of software accommodated by each equipment item.

In each airplane, an on-board configuration report system enables the maintenance operator to request that each on-board equipment item provide its internal configuration. This configuration report system then displays the configuration information received from the equipment item so that the maintenance operator can compare the information received and the information extracted from the system of reference on the ground. If a configuration does not correspond, a software uploading can be performed. That represents a large quantity of information to be displayed and verified, which increases the risk of a human error. Moreover, multiple occurrences of the same on-board system necessary for redundancy requirements entail an additional risk of error.

Recent airplane developments show:

an increasing number of equipment items accommodating “Field Loadable Software” (FLS),

an increasing number of FLS (acronym for “field loadable software” for software that can be uploaded on avionics) per LRU (acronym for “Line Replaceable Unit” for exchangeable equipment on an airplane) corresponding to different functions of the airplane, provided by different suppliers,

an increasing complexity of the software architecture requiring compatibility verifications performed by an operator, and

a redundancy of on-board systems leading to a multitude of LRU occurrences accommodating the same FLS configuration on board the airplane in different positions.

On the new airplanes:

the risk of human error is increased because of the number of product references (“part number”) to be verified by the operator following a single software uploading,

the risk of incompatibility and the risk of problems of interactions of configurations is increased because of the complexity of the software architecture, and

the configuration report function must be robust and its procedures must be more restrictive from the viewpoint of the risk of coherent corruption of displayed configuration information (in English “coherent corruption of displayed configuration information”) due to the multiple occurrences of the same redundant on-board systems.

For all these reasons, the configuration report function must be improved and simplified in order to reduce the workload of the operator, the duration of his participation and the risks of human error that are connected therewith.

To this end, according to a first aspect, this invention applies to a method for processing of at least one software configuration report for a data-processing equipment item, which comprises, for each said equipment item:

a step of determining, by a system remote from the said equipment item, of a verification sum calculated on a nominal product reference list for the pieces of software accommodated by the said equipment item,

a step of determining, by the said equipment item, of a verification sum calculated on a product reference list for the pieces of software actually accommodated by the said equipment item, and

a step of transmitting of the said verification sum determined by the said equipment item.

Depending on specific characteristics, in the course of each step of determining a verification sum, the verification sum is, moreover, calculated on an information item relating to the location of the equipment item.

Depending on specific characteristics, the said information item relating to the location of the equipment comprises an LRU name.

Depending on specific characteristics, the said information item relating to the location of the equipment item comprises a physical location of the equipment item.

Depending on specific characteristics, the said information relating to the location of the equipment item comprises a FIN (acronym for “Functional Item Number” for a functional part number).

Depending on specific characteristics, in the course of each step of determining a verification sum, the said product reference list for the accommodated software is exhaustive.

Depending on specific characteristics, the method that is the object of this invention, such as briefly set forth above, comprises a step of providing a result of comparison of the said software product reference lists.

Depending on specific characteristics, in the course of the step of transmitting, the said verification sum is transmitted together with an overall configuration information item for the equipment item.

Depending on specific characteristics, the said overall configuration information item for the equipment item comprises the product reference list for the pieces of software accommodated.

Depending on specific characteristics, during the step of transmitting, the said equipment item transmits the verification sum remotely, the step of comparing being performed remotely from the equipment.

According to a second aspect, this invention applies to a device for processing of at least one software configuration report for a data-processing equipment item, which comprises, for each said equipment item:

a means for determination, by a system remote from the said equipment item, of a verification sum calculated on a nominal product reference list for the pieces of software accommodated by the said equipment item, and

a means for receipt, from the said equipment item, of a verification sum calculated on a product reference list for the pieces of software actually accommodated by the said equipment item.

Since the advantages, purposes and specific characteristics of this device are similar to those of the method that is the object of this invention, such as briefly set forth above, they are not repeated here.

Other advantages, purposes and characteristics of this invention will become apparent from the description that is going to follow, presented with an explicative and in no way limitative intent with reference to the attached drawings, in which:

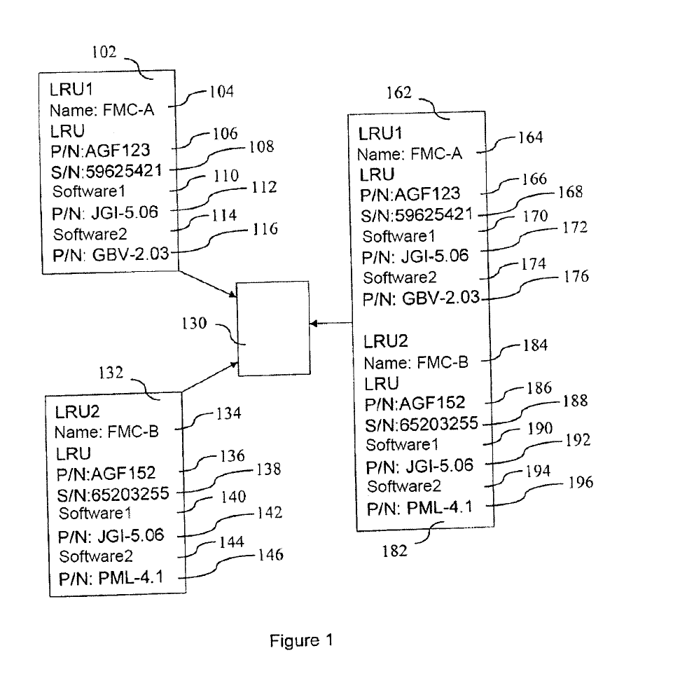

FIG. 1 schematically shows data to be processed by an operator, in accordance with the prior art,

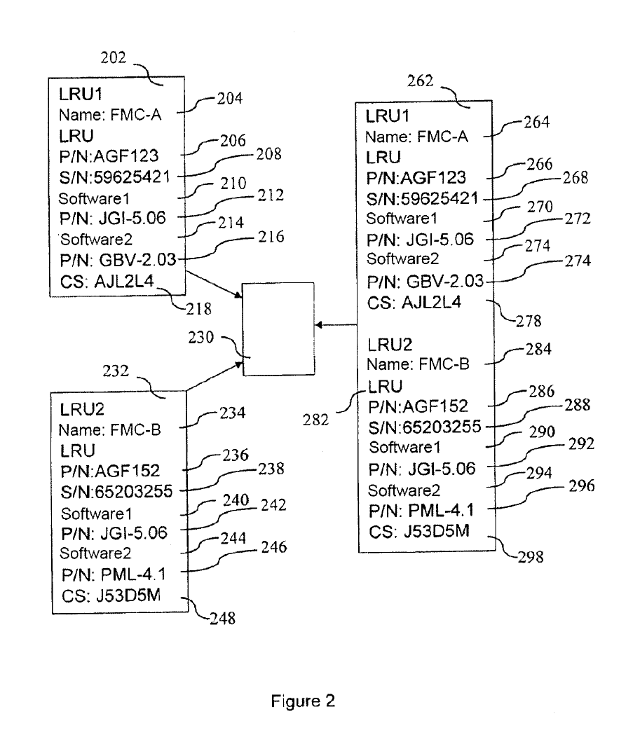

FIG. 2 schematically shows data to be processed by an operator, in accordance with a first embodiment of the method that is the object of this invention,

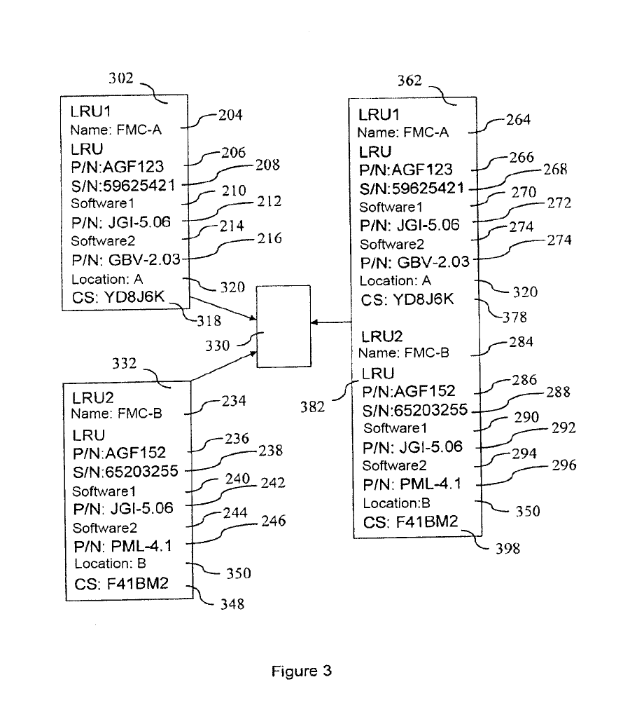

FIG. 3 schematically shows data to be processed by an operator, in accordance with a second embodiment of the method that is the object of this invention,

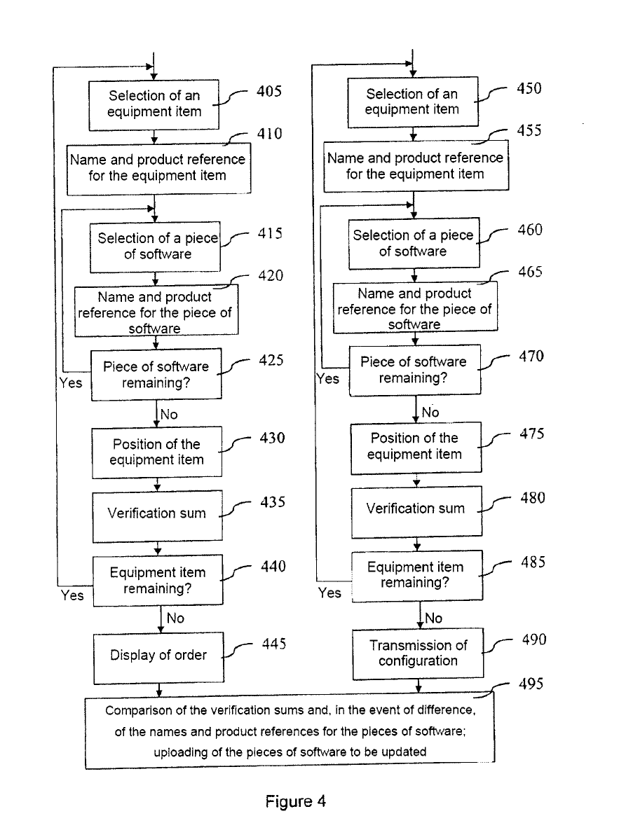

FIG. 4 shows, in the form of a logic diagram, steps employed in the second embodiment of the method that is the object of this invention, and

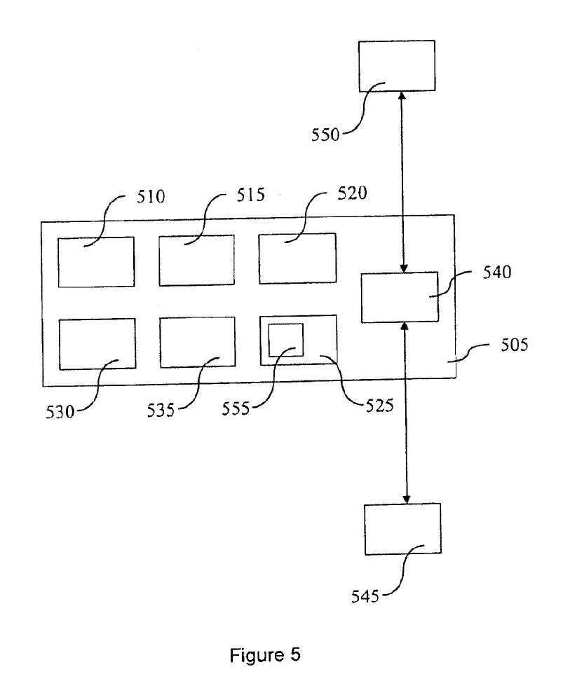

FIG. 5 schematically shows a specific embodiment of the device that is the object of this invention.

In the description, only avionic equipment items consisting of LRU (acronym for “Line Replaceable Unit” for exchangeable equipment on an airplane) are described. This invention, however, is not limited to this type of equipment, but extends, quite to the contrary, to all types of equipment items that can accommodate pieces of software found in an avionic system.

On FIG. 1 there are seen, to the left, elements 102 and 132 of configuration reports that a configuration report processing function 130 receives from the avionic equipment items and, to the right, elements 162 and 182 of an engineering order (in English “engineering order”) that the configuration report processing function 130 receives from a tool on the ground, in systems of the prior art. Here it is limited to the case in which two LRUs are involved and in which each LRU accommodates only two pieces of software.

Configuration report element 102 relates to a first LRU. It comprises, for this first LRU, a name field 104 for the LRU, a product reference field 106 for the first LRU, and serial number field 108 for the first LRU, a name field 110 for a first piece of software, a product reference field 112 for the first piece of software, a name field 114 for a second piece of software and a product reference field 116 for the second piece of software.

Configuration report element 132 relates to a second LRU. It comprises, for this second LRU, a name field 134 for the LRU, a product reference field 136 for the second LRU, and serial number field 138 for the second LRU, a name field 140 for a first piece of software, a product reference field 142 for the first piece of software, a name field 144 for a second piece of software and a product reference field 146 for the second piece of software.

Engineering order element 162 relates to the first LRU. It comprises, for this first LRU, a name field 164 for the LRU, a product reference field 166 for the first LRU, and serial number field 168 for the first LRU, a name field 170 for a first piece of software, a product reference field 172 for the first piece of software, a name field 174 for a second piece of software and a product reference field 116 for the second piece of software.

Engineering order element 182 relates to the second LRU. It comprises, for this second LRU, a name field 184 for the LRU, a product reference field 186 for the second LRU, and serial number field 188 for the second LRU, a name field 190 for a first piece of software, a product reference field 192 for the first piece of software, a name field 194 for a second piece of software and a product reference field 196 for the second piece of software.

As is easily understood upon reading of the foregoing, even in a very limited configuration with two LRUs each accommodating two pieces of software:

the configuration report elements comprise multiple occurrences of the same on-board system because of the redundancies required in avionic equipment items, and

the line-by-line comparison of the fields of the configuration report elements and the fields of the engineering order elements is tedious and subject to risks of human error which increase with the number of configuration report elements to be compared.

On FIG. 2 there are seen, to the left, elements 202 and 232 of configuration reports that a configuration report processing function 230 receives from the avionic equipment items and, to the right, elements 262 and 282 of an engineering order (in English “engineering order”) that the configuration report processing function 230 receives from a tool on the ground in a first specific embodiment of the method that is the object of this invention. Again, it is limited to the case in which two LRUs are involved and in which each LRU accommodates only two pieces of software.

Configuration report element 202 relates to a first LRU. It comprises, for this first LRU, a name field 204 for the LRU, a product reference field 206 for the first LRU, and serial number field 208 for the first LRU, a name field 210 for a first piece of software, a product reference field 212 for the first piece of software, a name field 214 for a second piece of software, a product reference field 216 for the second piece of software and a field 218 for a verification sum based on at least one product reference list for the pieces of software actually accommodated by the first LRU.

Configuration report element 232 relates to a second LRU. It comprises, for this second LRU, a name field 234 for the LRU, a product reference field 236 for the second LRU, and serial number field 238 for the second LRU, a name field 240 for a first piece of software, a product reference field 242 for the first piece of software, a name field 244 for a second piece of software, a product reference field 246 for the second piece of software and a field 248 for a verification sum based on at least one product reference list for the pieces of software actually accommodated by the second LRU.

Engineering order element 262 relates to the first LRU. It comprises, for this first LRU, a name field 264 for the LRU, a product reference field 266 for the first LRU, and serial number field 268 for the first LRU, a name field 270 for a first piece of software, a product reference field 272 for the first piece of software, a name field 274 for a second piece of software, a product reference field 216 for the second piece of software and a field 278 for a verification sum based on at least one nominal product reference list for the pieces of software accommodated by the first LRU.

Engineering order element 282 relates to the second LRU. It comprises, for this second LRU, a name field 284 for the LRU, a product reference field 286 for the second LRU, and serial number field 288 for the second LRU, a name field 290 for a first piece of software, a product reference field 292 for the first piece of software, a name field 294 for a second piece of software, a product reference field 296 for the second piece of software and a field 298 for a verification sum based on at least one nominal product reference list for the software accommodated by the second LRU.

As is easily understood upon reading of the foregoing, comparison of the actual and nominal configurations is easily performed by comparing the verification sums for the on-board equipment items. As compared with the case of FIG. 1, instead of 14 comparisons, the operator has no more than two comparisons to perform and it is only if these comparisons are negative, that is, if the verification sums do not correspond, that the operator compares the fields for the equipment item involved.

The first embodiment of this invention thus has the following advantages:

it considerably reduces the workload of the operator,

it reduces the risks of human error,

it reduces the time required for verifying the software configuration of all the equipment items of an airplane, and therefore the operating costs, and

in the event of non-agreement of the verification sums, the operator still can use the data comparison traditionally available in the configuration reports.

On FIG. 3 there are seen, to the left, elements 302 and 332 of configuration reports that a configuration report processing function 330 receives from the avionic equipment items and, to the right, elements 362 and 382 of an engineering order that the configuration report processing function 330 receives from a tool on the ground in a second specific embodiment of the method that is the object of this invention. Again, it is limited to the case in which two LRUs are involved and in which each LRU accommodates only 2 pieces of software.

Configuration report element 302 relates to the first LRU. It comprises, for this first LRU, the fields 204 to 216 described above and a field 318 for a verification sum based on at least one product reference list for the pieces of software actually accommodated by the first LRU and an information item 320 relating to the location of the first LRU.

For example, the information item relating to the location of the equipment item comprises an LRU name, a physical location of the equipment item or a FIN (acronym for “Functional Item Number” for a functional element number).

Configuration report element 332 relates to the second LRU. It comprises, for this second LRU, the fields 234 to 246 described above and a field 348 for a verification sum based on at least one product reference list for the pieces of software actually accommodated by the second LRU and an information item 350 relating to the location of the second LRU.

Engineering order element 362 relates to the first LRU. It comprises, for this first LRU, the fields 264 to 276 described above and a field 378 for a verification sum based on at least one nominal product reference list for the pieces of software accommodated by the first LRU and information item 320 relating to the location of the first LRU used to calculate the verification sum of field 318.

Engineering order element 382 relates to the second LRU. It comprises, for this second LRU, the fields 284 to 296 described above and a field 398 for a verification sum based on at least one nominal product reference list for the pieces of software accommodated by the second LRU and information item 350 relating to the location of the second LRU used to calculate the verification sum of field 348.

As is easily understood upon reading of the foregoing, comparison of the actual and nominal configurations is easily performed by comparing the verification sums of the on-board equipment items. In addition to the advantages of the first embodiment, set forth with reference to FIG. 2, in this second embodiment the risks of confusion among LRUs identical and redundant but positioned at different locations in the airplane are reduced, since the verification sums of their configuration reports, which depend on these locations, are different.

The verification sums set forth here are, for example, of type CRC (acronym for “Check Redundancy Code” for verification redundancy code), SHA (acronym for “Secure Hash Algorithm” for secured hash algorithm) or MD5 (acronym for “Message Digest 5” for “Message concatenation 5”).

The physical location of each equipment item possibly also is present in each configuration report and engineering order element.

Preferentially, the verification sum is calculated on the exhaustive list of pieces of software accommodated by the avionic equipment item involved.

It is seen that the first embodiment has disadvantages in comparison with the second embodiment:

for successive configuration verifications of redundant on-board systems, even if the risk of coherent corruption of displayed configuration information (in English “coherent corruption of displayed configuration information”) due to the multiple occurrences of the same redundant on-board systems is considered as nonexistent, it is not known how to prove it by means of the methodologies for security analysis. That is due mainly to the DAL (acronym for “Design Assurance Level” for a level of design assurance) for development of the configuration reporting function which is inferior to that for verifications of equipment items, and

it requires additional industrial methods for verification of the FLS (acronym for “field loadable software” for software that can be uploaded on avionics) processes.

On the contrary, the second implementation does not have these disadvantages. For the specific cases of redundant on-board avionic systems, it has the advantage of providing different verification sums for the same configuration in two different positions. It therefore covers the risk of coherent corruption of displayed configuration information since the verification sums are systematically different for the different on-board equipment items. This advantage is valid irrespective of the design assurance level (DAL) for development.

It is seen in FIG. 4 that the second embodiment of the method that is the object of this invention comprises, on the ground tool side, first a step 405 of selecting a first on-board avionic equipment item. Then, in the course of a step 410, the name of the current equipment item, its product reference and its serial number are determined and they are inserted in an engineering order.

In the course of a step 415, there is selected, in an exhaustive nominal list of an engineering order, a piece of software accommodated by the current equipment item. In the course of a step 420, the name of the current piece of software and its product reference are determined and they are inserted in the engineering order.

In the course of a step 425, it is determined whether the nominal list comprises at least one piece of software not yet selected. If yes, step 415 is repeated in order to select a piece of software that has not yet been selected. If no, in the course of a step 430, an information item representative of the position of the current equipment item is determined and it is inserted in the engineering order. In the course of a step 435, a verification sum is calculated on the basis of at least the nominal product reference list for the pieces of software accommodated by the current equipment item and the information item relating to the location of the current equipment item, and this verification sum is inserted in the engineering order.

In the course of a step 440, it is determined whether at least one equipment item has not yet been selected. If yes, step 405 is repeated in order to select an equipment item that has not yet been selected. If no, the engineering order is transmitted to the configuration report function and the engineering order is displayed in the course of a step 445.

On the on-board avionic system side, in the course of a step 450, a first on-board avionic equipment item is selected in the same manner as in the course of step 405, on the ground'tool side. Then in the course of a step 455, the name of the current equipment item, its product reference and its serial number are determined and they are inserted into a configuration report.

In the course of a step 460, there is selected, in an exhaustive list of pieces of software accommodated by the current equipment item, a piece of software accommodated by the current equipment item in the same manner as in the course of step 415. In the course of a step 465, the name of the current piece of software and its product reference are determined and they are inserted into the configuration report.

In the course of a step 470, it is determined whether at least one piece of software accommodated by the current equipment item has not yet been selected. If yes, step 460 is repeated in order to select a piece of software that has not yet been selected. If no, in the course of a step 475, an information item representative of the position of the current equipment item is determined and it is inserted in the configuration report. In the course of a step 480, there is calculated, with the same algorithm as in the course of step 435, a verification sum on the basis of at least the nominal product reference list for the pieces of software accommodated by the current equipment item and the information item relating to the location of the current equipment item, and this verification sum is inserted in the configuration report.

In the course of a step 485, it is determined whether at least one equipment item has not yet been selected. If yes, step 450 is repeated in order to select an equipment item that has not yet been selected. If no, the configuration report is transmitted to the configuration report function, in the course of a step 490. Preferentially, in the course of step 490 of transmitting, the said verification sum is transmitted together with an overall configuration information item for the equipment item.

The operator or the configuration report function then compares the verification sums and, if need be, the other report elements. In the event of difference, each piece of software different from the nominal software is uploaded in the avionic system, in the course of a step 495.

Preferentially, in the course of step 495, providing the comparison result is carried out together with providing the said nominal product reference list for the pieces of software accommodated by the said equipment item.

It is noted here that what is called the “configuration report function” is embodied by a data-processing system that can be integrated into the ground tool, into the on-board system, or be independent of these systems, for example by assuming the form of a portable personal computer. This function is equipped with software adapted for the receipt of the order of engineering and/or the configuration report, for the display of these elements and, if need be, for the comparison of the verification sums.

In FIG. 5 there is seen such a portable computer 505 comprising a central unit 510, a display screen 515, a random-access memory 520, a non-volatile memory 525, a keyboard 530, a pointing device 535 and a peripheral 540 for communication with the ground tool 545 and with the avionic system 550.

Non-volatile memory 525 retains a piece of software 555 comprising instructions interpretable by central unit 510 in order to implement a part of the method that is the object of this invention, for example such as set forth with reference to FIG. 4, for receipt of the engineering order, the configuration report, with display of these elements and, if need be, comparison of the verification sums.

1. Method for processing at least one software configuration report for a data-processing equipment item, which comprises, for each said equipment item:
a step of determining, by a system remote from the said equipment item, of a verification sum calculated on a nominal product reference list for the pieces of software accommodated by the said equipment item,
a step of determining, by the said equipment item, of a verification sum calculated on a product reference list for the pieces of software actually accommodated by the said equipment item, and
a step of transmitting the said verification sum determined by the said equipment item.

2. Method according to claim 1, in which, in the course of each step of determining a verification sum, the verification sum is, moreover, calculated on an information item relating to the location of the equipment item.

3. Method according to claim 2, in which the said information item relating to the location of the equipment item comprises an LRU (acronym for “Line Replaceable Unit” for exchangeable equipment on an airplane) name.

4. Method according to claim 2, in which the said information item relating to the location of the equipment item comprises a FIN (acronym for “Functional Item Number” for a functional part number).

5. Method according to claim 1, in which, in the course of each step of determining a verification sum, the said product reference list for the software accommodated is exhaustive.

6. Method according to claim 1, which comprises a step of providing a result of comparison of the said software product reference lists.

7. Method according to claim 1, in which, in the course of the step of transmitting, the said verification sum calculated on a product reference list for the pieces of software actually accommodated by the said equipment item is transmitted together with an overall configuration information item for the equipment item.

8. Method according to claim 7, in which the said overall configuration information item for the equipment comprises the product reference list for the pieces of software accommodated.

9. Method according to claim 1, in which, in the course of the step of transmitting, the said equipment item remotely transmits the verification sum calculated on a product reference list for the pieces of software actually accommodated by the said equipment item, a step of comparing of the said software product reference lists being performed remotely from the equipment.

10. Device for processing at least one software configuration report for a data-processing equipment item, which comprises, for each said equipment item:
a means for determination, by a system remote from the said equipment item, of a verification sum calculated on a nominal product reference list for pieces of software accommodated by the said equipment item, and
a means of receipt, from the said equipment item, of a verification sum calculated on a product reference list for the pieces of software actually accommodated by the said equipment item.

11. Device according to claim 10, in which the means for determination of a verification sum is adapted so that each verification sum is, moreover, calculated on an information item relating to the location of the equipment item.

12. Device according to claim 1, in which the means for determination of a verification sum is adapted so that the said information item relating to the location of the equipment item comprises an LRU (acronym for “Line Replaceable Unit” for exchangeable equipment on an airplane) name.

13. Device according to claim 11, in which the means for determination of a verification sum is adapted so that the said information item relating to the location of the equipment item comprises a FIN (acronym for “Functional Item Number” for a functional part number).

14. Device according to claim 10, in which the means for determination of a verification sum is adapted so that the said product reference list for the pieces of software accommodated is exhaustive.

15. Device according to claim 10, which comprises a means for providing a result of comparison of the said software product reference lists.

16. Device according to claim 10, in which the means for receipt is adapted so that the said verification sum calculated on a product reference list for the software actually accommodated by the said equipment is received together with an overall configuration information item for the equipment item.

17. Device according to claim 16, in which the means for receipt is adapted so that the said overall configuration information item for the equipment item comprises the product reference list for the pieces of software accommodated.

18. Method according to claim 10, which comprises a means for comparison of the said software product reference lists.
